(19) United States
(12) Patent Application Publication
(10) Pub. No.: US 2026/0296848 A1
(43) Pub. Date: Oct. 1, 2026

(54) COUNTERWEIGHT ASSEMBLY AND SYSTEM FOR MOUNTING THE COUNTERWEIGHT ASSEMBLY

(71) Applicant: Caterpillar Inc., Peoria, IL (US)

(72) Inventors: Jason James Forck, Chillicothe, IL (US); Dhamodharan Vimala, Tiruvannamalai (IN); Karthikeyan Kubendhiran, Coimbatore (IN)

(73) Assignee: Caterpillar Inc., Peoria, IL (US)

(21) Appl. No.: 19/093,710

(22) Filed: Mar. 28, 2025

(51) Int. Cl. B66C 23/74

(52) U.S. Cl. CPC B66C 23/74

(57) ABSTRACT

A counterweight assembly for a pipelayer is disclosed. The counterweight assembly includes a plurality of counterweight slabs. The counterweight assembly further includes a base plate configured to mount the plurality of counterweight slabs thereon. The plate includes one or more hook portions configured to mount the base plate to a mounting frame of the pipelayer. The plate further includes at least one lug portion configured to facilitate locking of the base plate to the mounting frame.

### TECHNICAL FIELD

The present disclosure relates to counterweight assemblies for pipelayers. More particularly, the present disclosure relates to a counterweight assembly and a system for mounting the counterweight assembly to the pipelayer.

### BACKGROUND

Pipelayers are generally used to suspend and place loads, such as pipelines, at an installation site or the like. The pipelayers are equipped with a boom for lifting and lowering loads during operations, such as a pipelaying operation. The boom is pivotally coupled to a side of the pipelayer and extends, or rotates, outward therefrom in a direction generally perpendicular to a forward travel direction of the pipelayer. The pipelayer may further include a counterweight assembly for balancing a weight of the pipelayer during lowering of loads at the installation site. The counterweight assembly needs to be removed from the pipelayer during transportation of the pipelayer. Current pipelayers utilize tools, such as wrenches, to remove the counterweights from the pipelayers which is time consuming and cumbersome process.

United States Patent No. 10,850,952 discloses a pipelayer machine having a counterweight assembly. The pipelayer machine can include a main body having first and second sides, a first side track provided on the first side of the main body and a second side track provided on the second side of the main body. A side boom can be provided on the first side of the main body. The counterweight assembly can be provided on the second side of the main body and include a counterweight mounting frame. A counterweight can be provided having a first side with an engagement hook extending from the first side. The engagement hook can be used to attach the counterweight to the counterweight mounting frame.

### SUMMARY OF THE INVENTION

In an embodiment, the present disclosure relates to counterweight assembly for a pipelayer. The counterweight assembly includes a plurality of counterweight slabs. The counterweight assembly further includes a base plate configured to mount the plurality of counterweight slabs thereon. The plate includes one or more hook portions configured to mount the base plate to a mounting frame of the pipelayer. The plate further includes at least one lug portion configured to facilitate locking of the base plate to the mounting frame.

In another embodiment, the present disclosure relates to a system for mounting a counterweight assembly to a pipelayer. The system includes one or more mounting frames operably coupled to the pipelayer. A first mounting frame of the one or more mounting frames includes an opening, a mounting hole, and a locking bore. The system further includes a base plate to mount a plurality of counterweight slabs of the counterweight assembly. The base plate includes at least one lug portion to be received within the opening. The at least one lug portion includes a through-hole. The system further includes a first pin configured to be received within the mounting hole and the through-hole to couple the base plate with the first mounting frame. The first pin defines a through-bore. The system further includes a second pin coupled to the first pin and configured to be received within the locking bore to lock the first pin and the base plate with the first mounting frame.

In another embodiment, the present disclosure relates to a method for mounting a counterweight assembly to a pipelayer. The method aligning a base plate of the counterweight assembly with first and second mounting frames of the pipelayer to insert respective lug portions of the base plate within respective openings of the first and second mounting frames. A first lug portion of the respective lug portions includes a through-hole. The first mounting frame includes a mounting hole and a locking bore. The method further includes inserting a first pin within the mounting hole and the through-hole to couple the base plate with the first mounting frame. The first pin defines a through-bore. The method further includes sliding a second pin into the locking bore of the first mounting frame and engaging the through-bore of the first pin to lock the first pin and the base plate with the first mounting frame.

### BRIEF DESCRIPTION OF THE DRAWINGS

FIG. 1 is a front view of an exemplary pipelayer having a counterweight assembly, according to some embodiments of the present disclosure;

FIG. 2 is a perspective view of a system for mounting the counterweight assembly to the work machine of FIG. 1, according to some embodiments of the present disclosure;

FIG. 3 is an exploded view of the system for mounting the counterweight assembly to the work machine of FIG. 1, according to some embodiments of the present disclosure;

FIG. 4-7 are steps for mounting the counterweight assembly to the frame of the work machine of FIG. 1, according to some embodiments of the present disclosure; and

FIG. 8 is a flow chart depicting an exemplary method for mounting the counterweight assembly to the work machine of FIG. 1, according to some embodiments of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

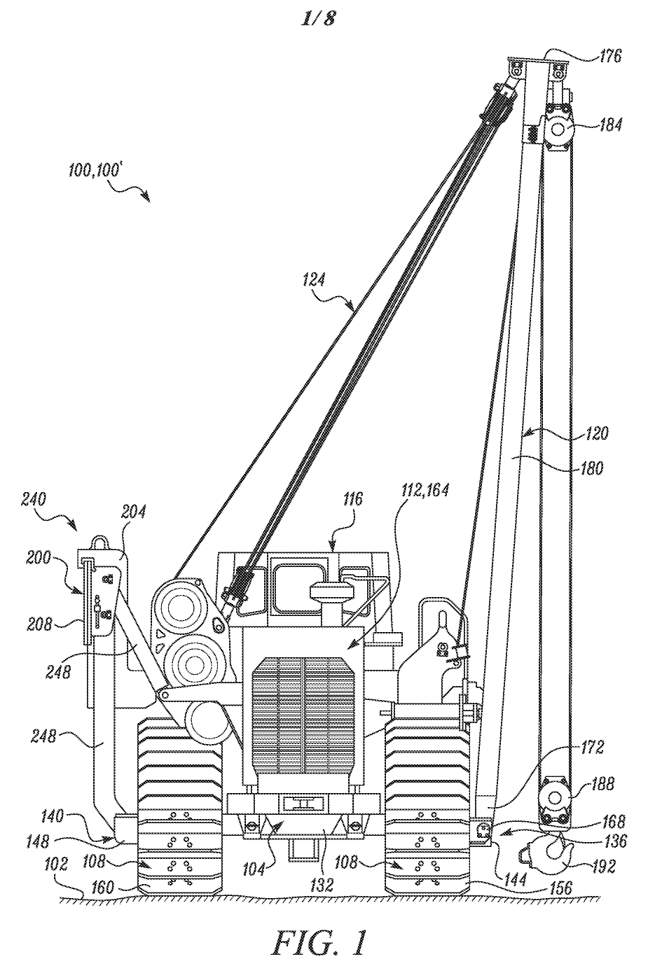

Referring to FIG. 1, an exemplary work machine 100 is shown. In the illustrated embodiment, the work machine 100 is embodied as a pipelayer 100` used to perform pipelaying operations. The pipelaying operations may include but not limited to lifting and/or lowering of a load, such as a conduit segment, a pipe segment, a culvert segment, a drainage segment, and the like, and installing the load at an installation site, such as a trench. In an exemplary pipelaying operation, a pipe segment (to be installed in a trench) is lifted-off of a work surface 102 (e.g., ground) by the pipelayer 100`, placed over top of the trench, and lowered into the trench by the pipelayer 100`.

Although references to the pipelayer 100` are used, aspects of the present disclosure may also be applicable to other work machines equipped with booms for suspending loads, such as dragline excavators, rope shovels, cranes, etc., and references to the pipelayer 100` in the present disclosure is to be viewed as purely exemplary.

The pipelayer 100` (or the work machine 100) includes a frame 104, traction devices 108, a propulsion system 112, an operator cabin 116, a boom 120, and a boom hoisting assembly 124. The frame 104 supports one or more components/assemblies of the pipelayer 100`, such as the propulsion system 112, the operator cabin 116, the boom 120, and the boom hoisting assembly 124, although other known components and structures may be supported by the frame 104, as well. The frame 104 may define a forward end 132 and a rearward end (not shown) opposite to the forward end 132. The forward end 132 and the rearward end may be defined in relation to an exemplary direction of travel of the pipelayer 100`, with said direction of travel being defined from the rearward end towards the forward end 132.

Also, the frame 104 may define two lateral sides, namely, a first lateral side 136 and a second lateral side 140 opposite to the first lateral side 136. The two lateral sides may be located transversely relative to the exemplary direction of travel of the pipelayer 100`. In addition, the frame 104 may include a first track roller frame 144 and a second track roller frame 148. The first track roller frame 144 may be disposed at the first lateral side 136 of the pipelayer 100`and the second track roller frame 148 may be disposed at the second lateral side 140 of the pipelayer 100`.

The traction devices 108 may support the frame 104 (and thus the pipelayer 100`) over the work surface 102 and may be powered by the propulsion system 112 to facilitate movement of the pipelayer 100` over an expanse of the installation site. The traction devices 108 may include tracks, or wheels, or a combination thereof. As shown in FIG. 1, the pipelayer 100` includes two traction devices 108, namely, a first track 156 and a second track 160. The first track 156 may be coupled to the first track roller frame 144 and, the second track 160 may be coupled to the second track roller frame 148. In other embodiments, it may be contemplated that higher or lesser number of tracks may be used in the pipelayer 100`.

The propulsion system 112 may include a power compartment 164 and a power source (not shown) provided within the power compartment 164. The power source may include a combustion engine, or an electrical power source, or a combination thereof. The power source may be configured to generate an output power required to operate various systems or assemblies on the pipelayer 100`, with one operation exemplarily involving a pivoting of the boom 120 with respect to the frame 104 to lift or lower loads.

The operator cabin 116 may be supported over the frame 104. The operator cabin 116 may facilitate stationing of one or more operators therein, to monitor and control the operations of the pipelayer 100. Also, the operator cabin 116 may house various components and controls of the pipelayer 100`, access to one or more of which may help the operators to perform the pipelaying operations. For example, the various components and controls of the pipelayer 100` may include, but not limited to, joysticks, switches, and the likes, to facilitate an operator in performing the pipelaying operations.

The boom 120 may be disposed on the first lateral side 136 of the frame 104. The boom 120 is pivotally coupled to the frame 104 at a pin joint 168 (located at the first lateral side 136 of the frame 104). It should be noted that the pin joint 168 may refer to any type of joint that facilitates pivoting movement of the boom 120 with respect to the frame 104. Examples of the pin joint 168 may include, but not limited to, a hinge joint, a ball and socket joint, a cylindrical joint, or any other type of articulated joint known in the art.

In an example, as shown in FIG. 1, the boom 120 defines a proximal end 172 pivotally coupled to the first track roller frame 144 (of the frame 104) at the pin joint 168, and a distal end 176 opposite to the proximal end 172 and away from the frame 104. The boom 120 may include one or more legs 180, a first hook block 184 pivotally coupled to the legs 180 at the distal end 176, a second hook block 188 operably coupled to the first hook block 184 (e.g., via at least one hook cable 194, and a lifting hook 192 coupled to the second hook block 188 and configured to suspend the load, such as a pipe section, to be lifted (or lowered).

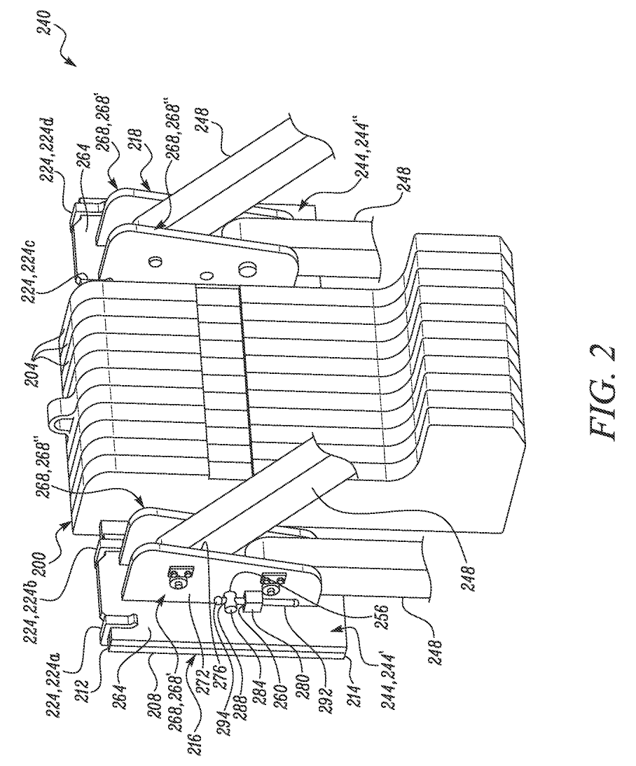

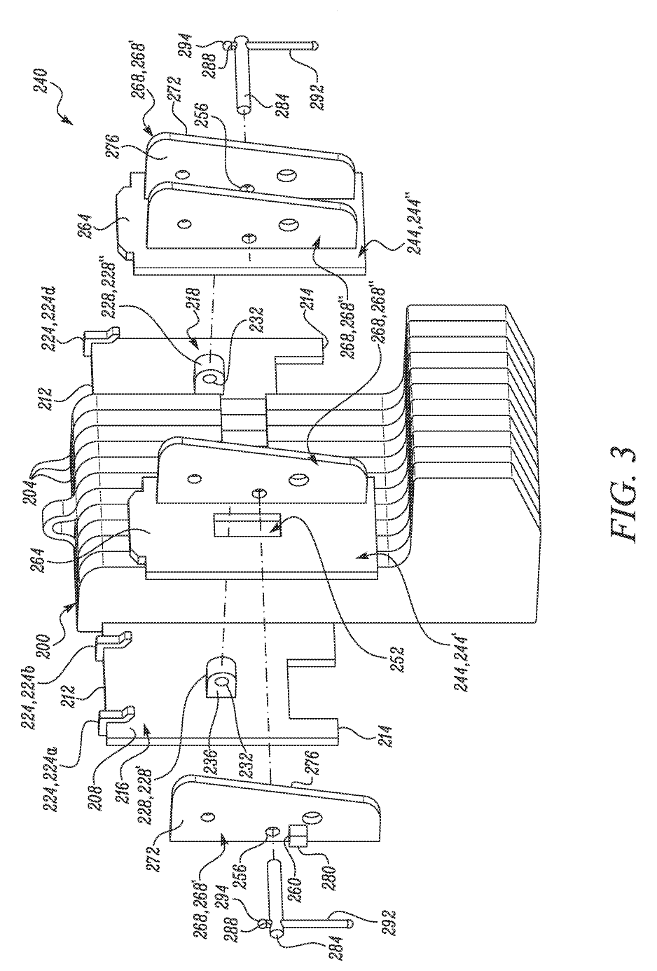

Referring now to FIGS. 2 to 3, the pipelayer 100` (or the work machine 100) includes a counterweight assembly 200. The counterweight assembly 200 may be supported by the frame 104 of the pipelayer 100`. The counterweight assembly 200 may be configured to counterbalance forces created as the boom 120 is extended during a lifting operation performed by the pipelayer 100`. For example, the counterweight assembly 200 may be configured to extend away from the frame 104 of the pipelayer 100` during the lifting operation. In an example, the boom 120 is located adjacent to the first lateral side 136 of the frame 104, and the counterweight assembly 200 may be provided adjacent to the second lateral side 140 of the frame 104.

The counterweight assembly 200 includes a plurality of counterweight slabs 204. Each of the counterweight slabs 204 may be assembled together (e.g., welded or bolted) into a unitized block. The counterweight assembly 200 further includes a base plate 208 configured to mount the plurality of counterweight slabs 204 thereon. In an example, the counterweight slabs 204 may be mounted on the base plate 208 by welding or fastening.

The base plate 208 may be made of a material having a high tensile strength. The base plate 208 may define a top end portion 212 and a bottom end portion 214 opposite to the top end portion 212. The top end portion 212 may be configured to mount the plurality of counterweight slabs 204 to the base plate 208. The base plate 208 may further define a first side portion 216 and a second side portion 218 spaced away from the first side portion 216. When mounted onto the base plate 208, the counterweight slabs 204 may be located between the first side portion 216 and the second side portion 218.

The base plate 208 further includes one or more hook portions 224 configured to mount the base plate 208 to the pipelayer 100`. In an example, the base plate 208 may include four hook portions 224 (a first hook portion 224a, a second hook portion 224b, a third hook portion 224c, a fourth hook portion 224d). In an example, the one or more hook portions 224 may be defined at the top end portion 212. Further, the one or more hook portions 224 may be located on the first side portion 216 and the second side portion 218 of the base plate 208. In an example, the hook portions 224 may be an integral part of the base plate 208, or may be fixedly coupled with the base plate 208 by any suitable method such as welding and the like. The hook portions 224 may be L-shaped members protruding from the top end portion 212 of the base plate 208, however, other shapes of the hook portions 224 may be contemplated.

The base plate 208 further includes at least one lug portion 228 configured to facilitate locking of the base plate 208 to the pipelayer 100`. In an example, the base plate 208 may include two lug portions 228, namely – a first lug portion 228` and a second lug portion 228``. The lug portions 228`, 228`` may be located between the top end portion 212 and the bottom end portion 214 of the base plate 208. Further, the lug portions 228`, 228`` may be located on the first side portion 216 and the second side portion 218, respectively, of the base plate 208. Each of the lug portions 228`, 228`` may include a through-hole 232. The through-hole 232 may be disposed on a side portion 236 of the lug portion 228.

To mount and couple the counterweight assembly 200 to the pipelayer 100`, a system 240 is disclosed. The system 240 may be configured to removably couple the counterweight assembly 200 to the pipelayer 100`. Further, the system 240 may be configured to facilitate quick and easy removal of the counterweight assembly 200 from the pipelayer 100`, for example, during transportation of the pipelayer 100`.

The system 240 includes one or more mounting frames 244 coupled to the pipelayer 100`. The one or more mounting frames 244 may include a first mounting frame 244` and a second mounting frame 244``. In an example, as shown in FIGS. 2 and 3, the second mounting frame 244`` may be spaced from the first mounting frame 244`. The first mounting frame 244` will now be discussed in greater detail, however, it may be contemplated that all the features of the first mounting frame 244` are applicable to the second mounting frame 244` without any limitations.

The first mounting frame 244` may be coupled to the pipelayer 100` by using one or more support members 248 (as shown in FIG. 2). The support members 248 may be operably coupled to the frame 104 of the pipelayer 100`. The support members 248 may be coupled to the frame 104 by any suitable means such as pins, fasteners, and the like. The first mounting frame 244` includes an opening 252, a mounting hole 256, and a locking bore 260. In an example, the opening 252, the mounting hole 256, and the locking bore 260 are oriented perpendicular to one another. In another example, the opening 252, the mounting hole 256, and the locking bore 260 may be oriented at any suitable angle with respect to each other.

In an example, the first mounting frame 244 may include a first plate 264. In an example, the opening 252 may be defined on the first plate 264. In an example, the first mounting frame 244` may include a first opening 252` and the second mounting frame 244`` may include a second opening 252``. In an example, the opening 252 may be a rectangular opening 252 formed on the first plate 264, however, different shapes of the opening 252 may be contemplated. In an example, the lug portion 228 may be received within the opening 252 of the first plate 264 of the mounting frame 244.

The first mounting frame 244 may include at least one second plate 268 protruding from the first plate 264. In an example, the first mounting frame 244` may include a pair of second plates 268 (e.g., an outer second plate 268` and an inner second plate 268``). The second plate 268 (the outer second plate 268`) may define a first surface 272 and a second surface 276 opposite to the first surface 272. In an example, the mounting hole 256 may be formed on each of the second plates 268`, 268``. For example, the mounting hole 256 may extend between the first surface 272 and the second surface 276 of each of the second plates 268`, 268``.

The first mounting frame 244` may further include a block 280 protruding from the second surface 276 of the second plate 268. The block 280 may be a cuboidal block 280, however, different shapes of the block 280 may be contemplated. In an example, the locking bore 260 may be defined in the block 280. For example, the locking bore 260 may be a through bore defined on the block 280 and may extend along a thickness of the block 280.

The system 240 further includes the base plate 208 of the counterweight assembly 200. As discussed above, the base plate 208 is configured to mount the plurality of counterweight slabs 204 of the counterweight assembly 200. For instance, the hook portions 224 (of the base plate 208) may facilitate mounting of the base plate 208 to the mounting frame 244, and the lug portions 228 may facilitate locking of the base plate 208 to the mounting frame 244.

Also, the system 240 includes a first pin 284. In an example, the first pin 284 may be a cylindrical rod. The first pin 284 may define a through-bore 288 disposed thereon. The through-bore 288 may be disposed at an end portion of the first pin 284. The first pin 284 may be configured to be received within the mounting hole 256 of the mounting frame 244. In an exemplary assembling process, the through-hole 232 of the lug portion 228 may be aligned with the mounting hole 256 of the first mounting frame 244` as the base plate 208 is mounted to the first mounting frame 244`, and subsequently, the first pin 284 may be received within the mounting hole 256 and the through-hole 232 to couple the base plate 208 with the first mounting frame 244.

The system 240 further includes a second pin 292. The second pin 292 may be a cylindrical rod having a coupling portion 294 at one end of the cylindrical rod. The second pin 292 may be configured to be coupled with the first pin 284. To couple with the first pin 284, the second pin 292 may be received within the through-bore 288 of the first pin 284. The second pin 292 may be further configured to be received in the locking bore 260 of the block 280. In some embodiments, a bottom end of the second pin 292 opposite the coupling portion 294 is sized to retain the second pin 292 with the first pin 284. In such embodiments, the bottom end of the second pin 292 is small enough in diameter to pass through the locking bore 260 but is too large in diameter to pass up and out of the through-bore 288 of the first pin 284. Therefore, the second pin 292 may not be removeable from the first pin 284 to prevent the second pin 292 from being lost.

In an exemplary assembling process, the first pin 284 may be inserted through the mounting hole 256 and the through-hole 232 in a manner that the through-bore 288 of the first pin 284 may be aligned with the locking bore 260 of the block 280. Subsequently, the second pin 292 may be inserted through the through-bore 288 (of the first pin 284) and the locking bore 260 (of the block 280) such that the coupling portion 294 of the second pin 292 may abut the through-bore 288 (of the first pin 284) to lock the first pin 284 and the base plate 208 with the first mounting frame 244. In an example, the second pin 292 may be inserted within the locking bore 260 of the block 280 by way of gravitational force. Once inserted, the second pin 292 may restrict a horizontal movement of the first pin 284 with respect to the mounting frame 244.

### Industrial Applicability

Counterweight assembly 200 may be used in any suitable work machine 100, such as the pipelayer 100`, to counteract the weight of an object (e.g., pipe) being lifted, for example, to increase lifting capacity and resist tipping. In addition, the counterweight assembly 200 may be removed from the pipelayer 100`, for example, during the transportation of the pipelayer 100`. Further, during operation of the pipelayer 100`, the counterweight assembly 200 may be mounted to the pipelayer 100`.

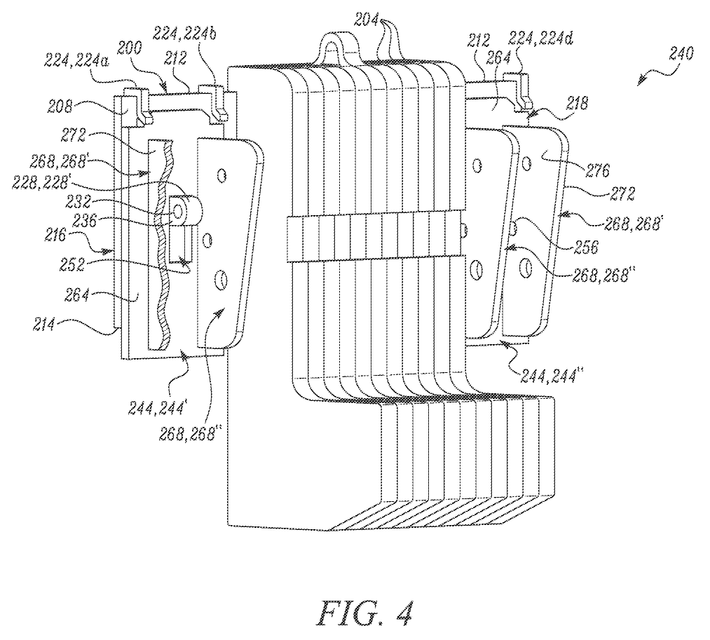

Referring now to FIGS. 4-7, an exemplary method for mounting the counterweight assembly 200 to the pipelayer 100`, is discussed. The method is discussed by way of a flowchart 800 that illustrates exemplary stages (e.g., 802, 804, and 806) associated with the method. It will be appreciated that the order of steps described in the method is exemplary in nature and that the steps can be performed in a different order than what is set out below, as will be contemplated by a person skilled in the art based on the description of the present disclosure.

The method begins aligning the base plate 208 of the counterweight assembly 200 with first and second mounting frames 244 of the pipelayer 100` to insert respective lug portions 228 of the base plate 208 within respective openings 252 of the first and second mounting frames 244 at block 802 (see FIG. 4). The aligning of the base plate 208 with the first mounting frame 244` and the second mounting frame 244`` may be carried out by a crane. The crane may lift the counterweight assembly 200 and place the counterweight assembly 200 such that the respective lug portions 228 may be positioned within the respective openings 252 of the mounting frame 244. For example, the first lug portion 228` may be placed within the first opening 252` of the first mounting frame 244` and the second lug portion 228`` may be placed within the second opening 252`` of the second mounting frame 244``.

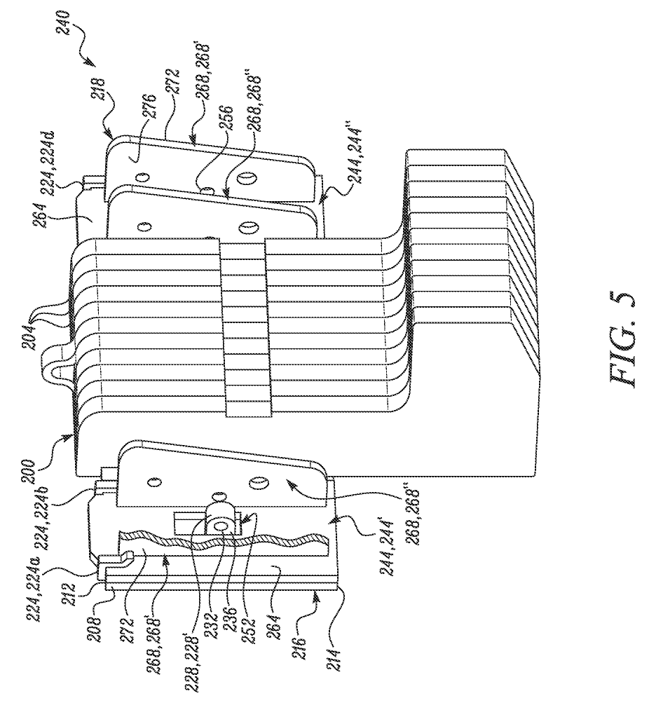

Further, the method may include aligning the mounting hole 256 of the first mounting frame 244` with the through-hole 232 of the first lug portion 228` of the respective lug portions 228 when the one or more hook portions 224 of the base plate 208 are placed on the first mounting frame 244` (see FIG. 5). In an example, the placing of the counterweight assembly 200 on the mounting frame 244 includes allowing the hook portions 224 to be rested on the first plate 264. Simultaneously, the lug portion 228 may slide within the opening 252 such that the through-hole 232 of the lug portion 228 (e.g., the first lug portion 228`) may be aligned with the mounting hole 256 of the second plate 268.

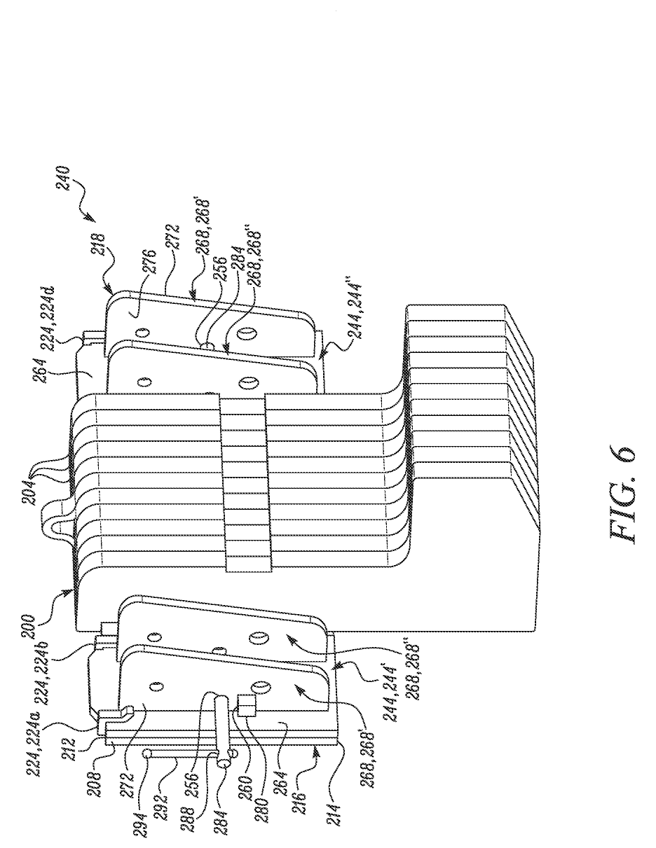

At block 804, the method includes inserting the first pin 284 within the mounting hole 256 and the through-hole 232 to couple the base plate 208 with the first mounting frame 244` (see FIG. 6). In an example, once the through-hole 232 and the mounting hole 256 are aligned, the method may include inserting the first pin 284 which may pass through the mounting hole 256 of the second plate 268 and the through-hole 232 of the lug portion 228 to engage the base plate 208 with the first mounting frame 244`. The first pin 284 may be inserted by an operator of the pipelayer 100` or may be inserted by automatic systems. In an example, another first pin 284 may be inserted within the mounting hole 256 of the second mounting frame 244`` and second lug portion 228`` simultaneously.

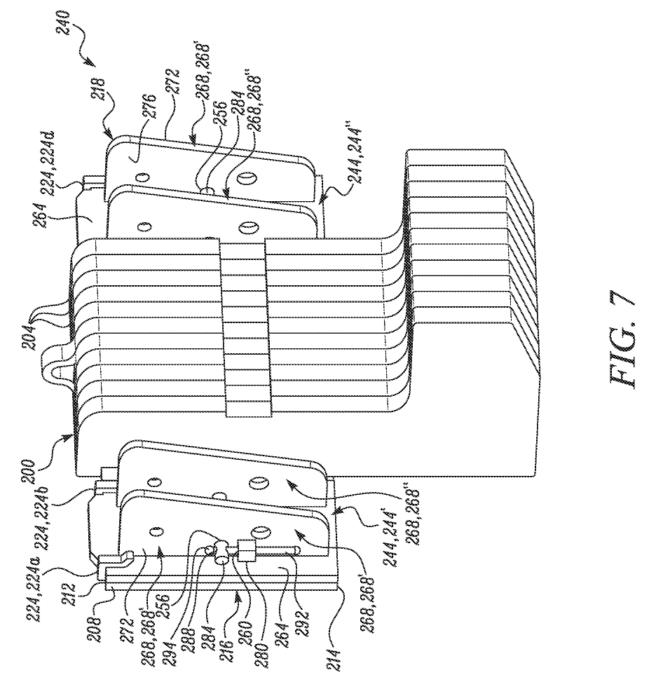

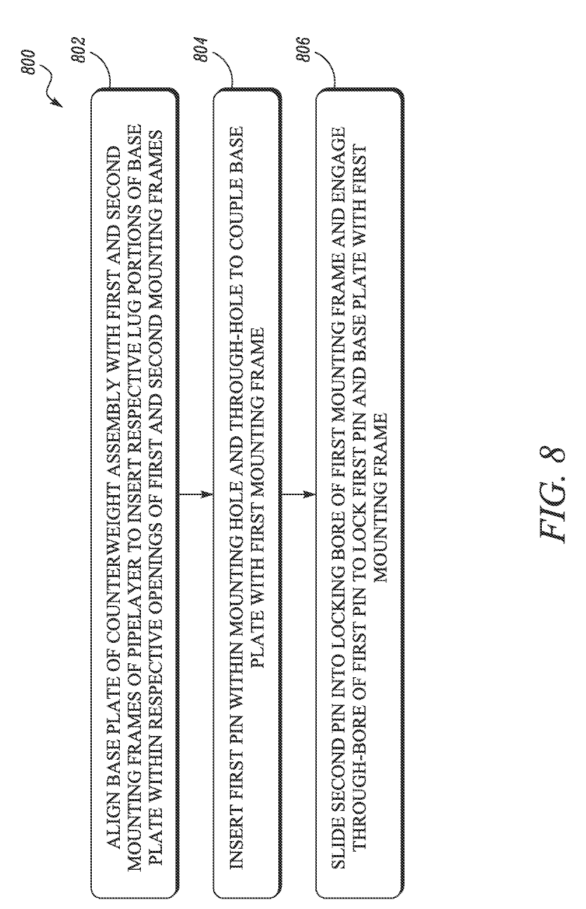

At block 806, the method includes sliding the second pin 292 into the locking bore 260 of the first mounting frame 244` and engaging the through-bore 288 of the first pin 284 to lock the first pin 284 and the base plate 208 with the first mounting frame 244` (see FIG. 7). In an example, once the first pin 284 is inserted within the mounting hole 256 and the through-hole 232, the method includes inserting the second pin 292 into the through-bore 288 of the first pin 284 which may be further inserted within the locking bore 260 of the block 280 of the first mounting frame 244`. In an example, another second pin 292 may be inserted within the through-bore 288 of the second mounting frame 244`` and locking bore 260 of another block 280 simultaneously.

The insertion of the second pin 292 within the through-bore 288 of the first pin 284 and the locking bore 260 of the block 280 allows the first pin 284 to be locked in the mounting hole 256 and the through-hole 232. The second pin 292 may restrict the horizontal movement of the first pin 284 out of the mounting hole 256 and the through-hole 232. The second pin 292 may remain in the locking bore 260 of the block 280 until an external force is applied on the second pin 292 to move the second pin 292 out of the locking bore 260.

The system 240 of the present disclosure may allow quick mounting and dismounting of the counterweight assembly 200 to and from the mounting frame 244 of the pipelayer 100`. The system 240 of the present disclosure prevents use of any tools such as wrenches, fasteners (e.g., nuts and bolts) that were used to mount a conventional counterweight assembly to the pipelayer 100`. Eliminating such tools may reduce time for the operator of the pipelayer 100` to mount/dismount the counterweight assembly 200 to and from the mounting frame 244 of the pipelayer 100` during maintenance, and/or transportation of the pipelayer 100.

The removal of any tools such as wrenches, fasteners (e.g., nuts and bolts) may reduce a number of parts of the counterweight assembly 200 thus reducing overall weight and cost of the counterweight assembly 200. The system 240 of the present disclosure may improve efficiency of the pipelayer 100` by eliminating a need for specialized tools during setup, maintenance, and/or transportation of the pipelayer 100` from one worksite to another worksite.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A counterweight assembly for a pipelayer, the counterweight assembly comprising:
a plurality of counterweight slabs;
a base plate configured to mount the plurality of counterweight slabs thereon and including:
one or more hook portions configured to mount the base plate to a mounting frame of the pipelayer; and
at least one lug portion configured to facilitate locking of the base plate to the mounting frame.

2. The counterweight assembly of claim 1, wherein the base plate defines a top end portion configured to mount the plurality of counterweight slabs to the base plate, and a bottom end portion opposite to the top end portion, and wherein the one or more hook portions are defined at the top end portion, and wherein the at least one lug portion is located between the top end portion and the bottom end portion.

3. The counterweight assembly of claim 1, wherein the base plate defines a first side portion and a second side portion spaced from the first side portion, wherein the one or more hooks and the at least one lug portion are defined at each of the first side portion and the second side portion, and wherein the plurality of counterweight slabs are located between the first side portion and the second side portion.

4. The counterweight assembly of claim 3, wherein the at least one lug portion includes a through-hole configured to be aligned with a corresponding mounting hole of the mounting frame when the base plate is mounted to the mounting frame to receive a first pin for locking the base plate to the mounting frame.

5. A system for mounting a counterweight assembly to a pipelayer, the system comprising:
one or more mounting frames operably coupled to the pipelayer, a first mounting frame of the one or more mounting frames including an opening, a mounting hole, and a locking bore;
a base plate to mount a plurality of counterweight slabs of the counterweight assembly, the base plate including at least one lug portion to be received within the opening, the at least one lug portion including a through-hole;
a first pin configured to be received within the mounting hole and the through-hole to couple the base plate with the first mounting frame, the first pin defining a through-bore; and
a second pin coupled to the first pin and configured to be received within the locking bore to lock the first pin and the base plate with the first mounting frame.

6. The system of claim 5, wherein the opening, the mounting hole, and the locking bore are perpendicular to one another.

7. The system of claim 5, wherein the first mounting frame of the one or more mounting frames includes:
a first plate, wherein the opening is defined at the first plate; and
at least one second plate protruding from the first plate, the at least one second plate defining a first surface and a second surface opposite to the first surface, wherein the mounting hole extends between the first surface and the second surface.

8. The system of claim 5, wherein the first mounting frame of the one or more mounting frames includes a block protruding from the second surface, and wherein the locking bore is defined in the block.

9. The system of claim 5, wherein the base plate includes one or more hook portions configured to mount the base plate to the first mounting frame of the pipelayer.

10. The system of claim 9, wherein the base plate defines a top end portion configured to mount the plurality of counterweight slabs to the base plate, and a bottom end portion opposite to the top end portion, and wherein the one or more hook portions are defined at the top end portion, and wherein the at least one lug portion is located between the top end portion and the bottom end portion.

11. The system of claim 9, wherein the base plate defines a first side portion and a second side portion spaced from the first side portion, wherein the one or more hooks and the at least one lug portion are defined at each of the first side portion and the second side portion, and wherein the plurality of counterweight slabs are located between the first side portion and the second side portion.

12. The system of claim 5, wherein the through-hole is configured to be aligned with the mounting hole of the first mounting frame of the one or more mounting frames when the base plate is mounted to the first mounting frame to receive the first pin for locking the base plate to the first mounting frame.

13. A method for mounting a counterweight assembly to a pipelayer, the method comprising:
aligning a base plate of the counterweight assembly with first and second mounting frames of the pipelayer to insert respective lug portions of the base plate within respective openings of the first and second mounting frames, wherein a first lug portion of the respective lug portions includes a through-hole, and wherein the first mounting frame includes a mounting hole and a locking bore;
inserting a first pin within the mounting hole and the through-hole to couple the base plate with the first mounting frame, the first pin defining a through-bore; and
sliding a second pin into the locking bore of the first mounting frame and engaging the through-bore of the first pin to lock the first pin and the base plate with the first mounting frame.

14. The method of claim 13, wherein the opening, the mounting hole, and the locking bore are perpendicular to one another.

15. The method of claim 13, wherein the first and second mounting frames includes:
a first plate, wherein the opening is defined at the first plate; and
at least one second plate protruding from the first plate, the at least one second plate defining a first surface and a second surface opposite to the first surface, wherein the mounting hole extends between the first surface and the second surface.

16. The method of claim 13, wherein the first and second mounting frames include a block protruding from the second surface, and wherein the locking bore is defined in the block.

17. The method of claim 13, wherein the base plate includes one or more hook portions configured to mount the base plate to the first mounting frame of the pipelayer and wherein the method includes aligning the mounting hole of the first mounting frame with the through-hole of the first lug portion of the respective lug portions when the one or more hook portions of the base plate are placed on the first mounting frame.

18. The method of claim 17, wherein the base plate defines a top end portion configured to mount a plurality of counterweight slabs to the base plate, and a bottom end portion opposite to the top end portion, and wherein the one or more hook portions are defined at the top end portion, and wherein the at least one lug portion is located between the top end portion and the bottom end portion.

19. The method of claim 17, wherein the base plate defines a first side portion and a second side portion spaced from the first side portion, wherein the one or more hooks and the at least one lug portion are defined at each of the first side portion and the second side portion, and wherein the plurality of counterweight slabs are located between the first side portion and the second side portion.

20. The method of claim 13, wherein the through-hole is configured to be aligned with the mounting hole of the first mounting frame when the base plate is mounted to the first mounting frame to receive the first pin for locking the base plate to the first mounting frame.
